(19) United States
(12) Patent Application Publication
(10) Pub. No.: US 2018/0111355 A1
(43) Pub. Date: Apr. 26, 2018

(54) PANE WITH THERMAL-RADIATION-REFLECTING COATING AND FASTENING OR SEALING ELEMENT ATTACHED THERETO

(71) Applicant: SAINT-GOBAIN GLASS FRANCE, Courbevoie (FR)

(72) Inventors: Florian MANZ, AACHEN (DE); Jan HAGEN, BONN (DE)

(21) Appl. No.: 15/562,889

(22) PCT Filed: May 10, 2016
(86) PCT No.: PCT/EP2016/060475

§ 371 Date: Sep. 28, 2017

(30) Foreign Application Priority Data
May 15, 2015 (EP) 15167777.0

(51) Int. Cl. B32B 17/10; C03C 17/42; C03C 17/34; B60J 10/90

(52) U.S. Cl. CPC B32B 17/10201; B60J 10/70; B32B 17/10761; B32B 17/1077; B32B 17/10788; C03C 17/42; C03C 17/3435; B60J 10/90; B32B 2307/412; B32B 2307/202; B32B 2307/416; B32B 2605/08; B32B 2309/105; C03C 2217/241; C03C 2217/213; C03C 2217/948; C03C 2217/281; C03C 2218/156; B32B 17/10293

(57) ABSTRACT

A pane for separating an interior from an external environment, at least including a substrate, and a thermal-radiation-reflecting coating on the interior-side surface of the substrate is disclosed. The coating has at least one functional layer containing a transparent conductive oxide and a topmost layer containing silicon dioxide, and a polymeric fastening or sealing element on the thermal-radiation-reflecting coating.

The invention relates to a pane with a thermal-radiation-reflecting coating and a fastening or sealing element attached thereto, a method for production thereof, and use thereof.

The interior of a motor vehicle can heat up greatly in the summer with high ambient temperatures and intense direct sunlight. When the outside temperature is lower than the temperature in the vehicle interior, which occurs in particular in the winter, a cold pane acts as a heat sink, which is perceived as unpleasant by the occupants. High heating performance of the climate control system must also be provided to prevent excessive cooling of the interior through the vehicle windows.

Thermal radiation reflecting coatings (so-called “low-E coatings”) are known. Such a coating reflects a significant part of sunlight, in particular in the infrared range, which, in the summer, results in reduced warming of the vehicle interior. Moreover, the coating reduces the emission of long-wave thermal radiation of a heated pane into the vehicle interior when the coating is applied on the surface of a pane facing the vehicle interior. Moreover, in the case of low outside temperatures in the winter, such a coating reduces the outward emission of heat from the interior into the external surroundings.

Vehicle windows are frequently provided with fastening or sealing elements. Examples of this include adhesive beads for fastening the pane to the motor vehicle body, sealing lips for sealing the gap between the pane and the motor vehicle body, or adhesives for applying attachment parts, for example, handles for opening the window, or a rearview mirror. The fastening or sealing elements can be produced and subsequently bonded on the pane or, in particular, even extruded directly onto the pane. Methods for the extruding on of polymeric elements are known, for example, from DE 196 04 397 C1, DE 42 32 554 C1, and DE 39 30 414 A1.

In the case of vehicle panes, these fastening or sealing elements are typically applied on the same surface as the low-E coating, i.e., on the interior-side surface. This can result in problems since the low-E coating is associated with a change in the surface properties of the pane, in particular affects the adhesion and adsorption properties of the pane. This negatively impacts the reproducible and stable attachment of fastening or sealing elements necessary for mass production. In addition, the presence of the low-E coating can weaken the adhesion of the fastening or sealing elements on the pane.

To overcome this problem, it is possible to implement the low-E coating of the region of the pane on which the fastening or sealing element is to be attached without coating. Thus, for instance, a peripheral edge region of the pane on which an adhesive bead or sealing lip is to be arranged can be freed of the coating after the fact or already be excluded at the time of application of the coating by masking techniques. However, this makes the production of the pane more difficult.

European patent EP 2 639 032 B1 discloses a low-E coating with a cover layer made of silicon nitride (Si₃N₄), which enables the direct application of a fastening or sealing element. The low-E coating includes a functional layer based, for example, on niobium or silver, typical materials for low-E coatings as is known, for example, from US 20110146172 A1, EP 1 218 307 B1, EP 2 247 549 A2, EP 877 006 B1, EP 1 047 644 B1, and EP 1 917 222 B1. These low-E coatings are compatible with the Si₃N₄ cover layer.

However, low-E coatings based on transparent conductive oxides (TCOs) are also known, for example, from WO 2013/131667 A1. Compared to niobium-based low-E coatings, these have the advantage that they are transparent and can, consequently, be used on window panes intended to be seen through. Compared to silver-based low-E coatings, they have the advantage that they are corrosion resistant and can, consequently, be used on a surface of the pane exposed to atmospheric influences. TCO-based low-E coatings are, however, not compatible with the Si₃N₄ cover layer proposed in EP 2 639 032 B1, since this results, due to the difference in the refractive index with the TCO layer, in inadequate anti-reflection of the coating such that its use on transparent panes is only possible with large losses in terms of optical quality.

The object of the present invention is to provide an improved pane with a TCO-based low-E coating, wherein a fastening or sealing element can be attached to the low-E coating, as well as a method for its production.

The object of the present invention is accomplished according to the invention by a pane with a thermal-radiation-reflecting coating according to claim 1. Preferred embodiments emerge from the subclaims.

The pane according to the invention is provided for separating an interior from an external environment. For this, the pane is preferably inserted in an opening, in particular, a window opening. That surface of the pane or its substrate that is intended, in the installed position, to face the interior is referred to in the context of the invention as the interior-side surface.

The pane according to the invention is, in particular, a window pane. In a preferred embodiment, the pane is a vehicle pane, in particular a motor vehicle pane, for example, the pane of a passenger car, a truck, and a train. With such panes, polymeric fastening or sealing elements are quite common. The pane can, for example, be a roof panel, windshield, side pane, or rear pane. In a particularly preferred embodiment of the invention, the pane is a roof panel, windshield, or front side window, because, for this application, transparent coatings are required, which is ensured by the TCO-based coating according to the invention. The invention is, however, equally usable in the construction sector, such that the pane according to the invention can also be an architectural glazing, e.g., a multipane glazing.

The pane according to the invention comprises at least a substrate, a thermal-radiation-reflecting coating on the interior-side surface of the substrate, and a polymeric, in particular elastomeric fastening or sealing element on or over (above) the thermal-radiation-reflecting coating. According to the invention, the thermal-radiation-reflecting coating is situated between the interior-side surface of the substrate and the fastening or sealing element. Accordingly, the fastening or sealing element is farther from the interior-side surface of the substrate than the thermal-radiation-reflecting coating. The fastening or sealing element can, in one embodiment of the invention, be arranged directly on or over the thermal-radiation-reflecting coating, i.e., in direct physical contact with the thermal-radiation-reflecting coating. In an alternative embodiment, the fastening or sealing element is not arranged in direct physical contact with the thermal-radiation-reflecting coating on or over the thermal-radiation-reflecting coating such that another component of the pane, for example, an opaque masking print or a primer, is situated between the thermal-radiation-reflecting coating and the fastening or sealing element.

The thermal-radiation-reflecting coating on the inside surface can also be referred to as a low-E coating—in the summer, it reduces the emission of thermal radiation of the pane into the interior and, in the winter, the outward radiation of heat into the external environment. The thermal-radiation-reflecting coating has at least one functional layer containing a transparent conductive oxide (TCO). Typically, the coating has, in addition to the functional layer, one or a plurality of dielectric layers which serve for antireflection or as a barrier layer.

According to the invention, this topmost layer, on which the fastening or sealing element is attached, contains silicon dioxide (SiO₂). In the context of the invention, the topmost layer is that layer of the layer stack that is farthest from the substrate.

The inventors realised that a layer based on SiO₂ is, on the one hand, compatible with a TCO-based low-E coating, because it has a suitable refractive index and adequate antireflection is ensured. The coating according to the invention thus does not undesirably reduce the transparency of the pane by reflection effects. On the other hand, the layer based on SiO₂, when it is used as the topmost layer of the layer stack, enables attaching the fastening or sealing element to the coating. The adhesion of the fastening or sealing element is not substantially impaired by the coating according to the invention. Removal of the coating in the region of the fastening or sealing element thus becomes unnecessary. In particular, the direct attachment of the fastening or sealing element in direct physical contact can be improved with the layer based on SiO₂. This is a major advantage of the present invention.

The coating according to the invention has another major advantage: it can be printed on. The pane, along with the coating, can unproblematically be provided with an opaque masking print customary in vehicle manufacturing. Such a masking print is typically made of an enamel that is applied to the pane (for example, by screenprinting) and fired. In a preferred embodiment, the pane is provided with such an opaque masking print, which is arranged between the thermal-radiation-reflecting coating and the fastening or sealing element. The inventors realised that such a masking print can be applied directly onto the coating according to the invention with the topmost layer based on SiO₂. Other cover layers, such as, for instance, the Si₃N₄ cover layer proposed in EP 2 639 032 B1, result in problems when printed on, for example, blistering or defective adhesion of the printing ink. The fastening or sealing element adheres unproblematically to the masking print.

The invention thus enables the production of panes without having to remove the coating in regions for attachment of the fastening or sealing element, whether it be by direct attachment of the fastening or sealing element on the coating or by application of a masking print on the coating, on which the fastening or sealing element is, in turn, attached.

The fastening or sealing element is preferably extruded. It is preferably extruded directly onto the pane, but can also be cured after extrusion and subsequently fastened on the pane. Suitable polymeric fastening or sealing elements are known per se to the person skilled in the art. The preferably extruded fastening or sealing element can, in particular, be or include:
a sealing lip
   Sealing lips are, in particular, customary in the automotive sector. They are arranged in the edge region of the pane along one or a plurality of side edges and protrude beyond the side edge. Sealing lips seal the gap between the pane and the vehicle body, by which means driving noises are reduced. Sealing lips are, however, also conceivable for other applications.
an adhesive bead for fastening the pane
   The adhesive bead is a strip of adhesive that is applied in the edge region substantially peripherally on one surface of the pane and enables gluing the pane into a window opening. Such adhesive beads are likewise customary in the automotive sector, in particular, but are also usable with other panes.
adhesive for fastening an attachment part on the pane
   Also, attachment parts are, in particular, customary in the automotive sector, for example, rearview mirrors, sensors or cameras, handles, encapsulations.

In a preferred embodiment, the fastening or sealing element contains polyurethane, polyolefin, polysulfide, poly-epoxy, rubber such as natural rubber, nitrile rubber (NBR), styrene butadiene rubber, butadiene acrylonitrile rubber, ethylene propylene diene rubber, silicone rubber such as RTV (room-temperature vulcanizing) silicone rubber, HTV (high-temperature-vulcanizing) silicone rubber, peroxide-vulcanizing silicone rubber, or addition-vulcanizing silicone rubber, polyacrylate, styrene/butadiene block copolymer (SBS), ethylene propylene diene rubber (EPDM), and/or a thermoplastic elastomer (TPE). These materials are, in particular, suitable for sealing lips or similar non-adhesive applications.

In another preferred embodiment, the fastening or sealing element contains heat-, moisture-, or UV-curing polymers, in particular moisture-reactive hot-melt adhesives, such as polyurethane-prepolymers, polyesters, polyolefins, polyamides, or mixtures or copolymers thereof, or hot-curing adhesives, such as polyurethanes, silicones, polyacrylates and poly-epoxies (epoxy resins) or mixtures thereof. These materials are, in particular, suitable for adhesive applications, such as adhesive beads or adhesive for attachment parts.

In a preferred embodiment, a primer is applied below the fastening or sealing element, i.e., between the thermal-radiation-reflecting coating and the fastening or sealing element. Thus, the adhesion of the fastening or sealing element is improved. Particularly good results are obtained when the primer contains polyisocyanate, reactive silane, methacrylate, and/or polyurethane.

The substrate contains or is preferably made of glass, in particular soda lime glass, which is customary as window glass. The substrate can, however, also contain other types of glass, such as quartz glass, borosilicate glass, or aluminosilicate glass or even plastics, in particular rigid, clear plastics, preferably polycarbonate (PC) or polymethylmethacrylate (PMMA). The substrate can be clear and transparent, but also tinted or coloured. The substrate can be flat (as customary in the architecture sector or in the case of large-area glazings of buses, trains, or tractors) or also be bent in one or a plurality of spatial directions (as customary in the automotive sector, in particular in passenger cars).

The thickness of the substrate can vary widely and thus be ideally adapted to the requirements in the individual case. Preferably, panes with the standard thicknesses from 1 mm to 10 mm and preferably from 1.4 mm to 6 mm are used. The size of the substrate can vary widely and is governed by the use according to the invention. The substrate has, for example, in motor vehicle manufacture and the architectural sector, customary areas from 200 cm² up to 20 m².

In a preferred embodiment, the substrate is part of a composite pane. The composite pane comprises an outer pane and an inner pane, which are bonded to one another via a thermoplastic intermediate layer. In the context of the invention, “outer pane” refers to the pane that is intended, in the installation position, to face the external environment. In the context of the invention, “inner pane” refers to that pane that is intended to face the interior. The substrate is the inner pane of the composite glass. The interior-side surface of the substrate is, consequently, also the interior-side surface of the composite pane. The outer pane is preferably made of glass, in particular soda lime glass, and has, for example, a thickness of 1 mm to 10 mm, preferably of 1.4 mm to 6 mm. The thermoplastic intermediate layer is typically implemented by a thermoplastic film containing, in particular, polyvinyl butyral (PVB), ethylene vinyl acetate (EVA), or polyurethane (PU). Typical thicknesses of the intermediate layer are from 0.3 mm to 1.10 mm, for example, 0.76 mm. Composite panes are, in particular, common as vehicle panes, typically as windshields or roof panels, but also increasingly as rear windows or side windows.

The substrate can also be connected to a second pane via a spacer to form an insulating glazing unit, wherein the substrate can be used optionally as either the outer pane or the inner pane.

The functional layer has reflecting properties for thermal radiation, in particular infrared radiation, and contains, according to the invention, at least one TCO. The advantage is the high optical transparency and chemical resistance of these materials. The functional layer preferably contains at least indium tin oxide (ITO), fluorine-doped tin oxide (SnO₂:F), or antimony-doped tin oxide (SnO₂:Sb), in particular ITO. Thus, particularly good results are obtained in terms of emissivity and coating properties. The refractive index of the materials of the functional layer is preferably from 1.7 to 2.5 (measured at a wavelength of 550 nm). The functional layer preferably contains at least 90 wt.-% of the TCO, particularly preferably at least 95 wt.-%, most particularly preferably at least 99 wt.-%. The functional layer can be made of the TCO or also have dopants.

The emissivity of the pane according to the invention can be influenced by the thickness of the functional layer. The thickness of the functional layer is preferably from 40 nm to 200 nm, particularly preferably from 70 nm to 150 nm, and most particularly preferably from 100 nm to 130 nm, for example, approx. 120 nm. In this range, the functional layer is, on the one hand, adequately thick to ensure advantageous emissivity, and, on the other, adequately thin to resist mechanical transformation such as bending or prestressing without damage.

The functional layer can, however, also include other transparent, electrically conductive oxides, for example, mixed indium zinc oxide (IZO), gallium-doped or aluminium-doped zinc oxide, niobium-doped titanium oxide, cadmium stannate, or zinc stannate.

The topmost layer of the coating according to the invention contains SiO₂. This has the advantage that the topmost layer functions, due to its refractive index, as an anti-reflection layer. The transparency of the coated substrate is thus increased such that the pane is also suitable as a window pane. Also considered as antireflection layers for TCO-based functional layers, are other oxidic materials, for example, titanium oxide (TiO₂) or zinc tin oxide (ZnSnO). The selection according to the invention of SiO₂ also surprisingly ensures, besides a suitable refractive index n<1.7, the adhesive properties according to the invention relative to the polymeric fastening or sealing element and the opaque masking print.

The topmost layer preferably contains at least 90 wt.-% of SiO₂, particularly preferably at least 92 wt.-%. The functional layer can be made of pure SiO₂ or can also have dopants, in particular aluminium (SiO₂:Al), boron (SiO₂:B), tin (SiO₂:Sn), titanium (SiO₂:Ti), zirconium (SiO₂:Zr), or hafnium (SiO₂:Hf).

The topmost layer preferably has a thickness of 20 nm to 150 nm, particularly preferably of 40 nm to 100 nm. This is particularly advantageous in terms of antireflective properties and adhesion properties.

In an advantageous embodiment, an adhesive layer is arranged below the functional layer. The adhesive layer results in durably stable adhesion of the layers deposited above the adhesive layer on the substrate. The adhesive layer further prevents the accumulation of ions diffusing out of the substrate in the boundary area to the functional layer, in particular of sodium ions, if the substrate is made of glass. Such ions can lead to corrosion and to low adhesion of the functional layer. The adhesive layer is, consequently, particularly advantageous in terms of the stability of the functional layer.

The material of the adhesive layer preferably has a refractive index in the range of the refractive index of the substrate. The material of the adhesive layer preferably has a lower refractive index than the material of the functional layer. The adhesive layer preferably contains at least one oxide, particularly preferably TiO₂, Al₂O₃, and/or ZnSnOₓ, most particularly preferably SiO₂. The adhesive layer preferably has a thickness from 10 nm to 150 nm, particularly preferably from 15 nm to 50 nm, for example, approx. 30 nm. This is particularly advantageous in terms of the adhesion of the coating according to the invention and the prevention of diffusion of ions from the substrate into the functional layer.

In an advantageous embodiment, a barrier layer that is suitable for preventing or reducing the uncontrolled oxidation of the functional layer during a transformation process of the pane (for example, bending or tempering) is arranged between the functional layer and the topmost layer. The barrier layer preferably contains silicon nitride (Si₃N₄), zirconium nitride (Zr₃N₄), or aluminium nitride (AlN), particularly preferably silicon nitride (Si₃N₄). The thickness of the barrier layer is preferably from 5 nm to 30 nm, particularly preferably 10 nm to 20 nm. Thus, particularly good results are obtained. The barrier layer can have dopants, for example, aluminium, zirconium, hafnium, titanium, or boron.

The interior-side emissivity of the pane according to the invention is preferably less than or equal to 30%, particularly preferably less than or equal to 25%. Here, the term “interior-side emissivity” refers to the measurement that indicates how much thermal radiation the pane gives off into an interior space, for example, of a building or a motor vehicle, in the installed position compared to an ideal thermal emitter (a black body). In the context of the invention, “emissivity” means the normal emission level at 283 K according to the standard EN 12898.

The invention further includes a method for producing a pane with a thermal-radiation-reflecting coating and a polymeric fastening or sealing element, wherein:
(a) a thermal-radiation-reflecting coating is applied on the interior-side surface of a substrate, wherein said coating has at least one functional layer containing a transparent conductive oxide (TCO) and a topmost layer containing silicon dioxide (SiO₂), and
(b) a polymeric fastening or sealing element is attached to said coating. The thermal-radiation-reflecting coating along with the topmost layer containing SiO₂ is not removed before attaching the fastening or sealing element.

The application of the coating in process step (a) is done by methods known per se, preferably by magnetically enhanced cathodic sputtering. This is particularly advantageous in terms of simple, quick, economical, and uniform coating of the substrate. The cathodic sputtering is done in a protective gas atmosphere, for example, of argon, or in a reactive gas atmosphere, for example, through addition of oxygen or nitrogen. However, the individual layers can also be applied by other methods known to the person skilled in the art, for example, by vapour deposition or chemical vapour deposition (CVD), by plasma enhanced chemical vapour deposition (PECVD), or by wet chemical methods.

After the application of the thermal-radiation-reflecting coating, the pane can be subjected to a temperature treatment. The substrate with the coating according to the invention is heated to a temperature of at least 200° C., particularly preferably at least 300° C. The crystallinity of the functional layer is, in particular, improved by the temperature treatment. Thus, the transmittance of visible light and the reflecting properties relative to thermal are significantly improved. The temperature treatment can also take place during a bending process, if the pane is to be bent. Typical bending temperatures are from 500° C. to 700° C. Alternatively, a temperature treatment can also be performed using laser radiation.

In an advantageous embodiment, between the process steps (a) and (b), a primer is applied on said coating, by which means the adhesion of the fastening or sealing element can be further improved. The primer is applied directly onto the SiO₂-based topmost layer. The primer is preferably applied in the form of a solution using a felt or a sponge on the surface to be adhered. The temperature is preferably between 10° C. and 40° C. The relative atmospheric humidity is preferably between 20% and 80%. The evaporation time is preferably 30 s to 3 days. The size and area of the primer applied is governed by the size of the fastening or sealing element to be attached subsequently. The primer is, for example, applied to an area from 2 cm² to 100 cm².

In a preferred embodiment, said coating is treated with a cleaning solution between the process steps (a) and (b). If a primer is to be used, the cleaning is done before the application of the primer. The cleaning solution preferably contains a silane, a surfactant, an alcohol, a ketone, or mixtures thereof.

In a particularly advantageous embodiment, the coating is treated—optionally before the application of the primer—by active cleaning. In active cleaning the surface is both cleaned and chemically activated. The active cleaning can be done both in separate cleaning and activation steps and in one step. In the cleaning step, adhering contaminants and production-related residues are removed. In the activation step, the surface is modified by surface-active substances. This can be done, for example, by the addition of reactive groups. Examples of reactive groups for glass substrates are silanes, in particular organic silane derivatives. Silanes that have suitable leaving groups, such as alcohols, can form a chemical bond with the free Si—O-surface of the topmost layer. Examples of such silanes are alkyltrimethoxysilanes and alkyltriethoxysilanes, for example, isooctyl trimethoxysilane (C11H26O3Si/CAS no. [Chemical Abstracts Number] 34396-03-7), octyl trimethoxysilane (C11H26O3Si/CAS no. 3069-40-7), octadecyl trimethoxysilane (C21H46O3Si/CAS no. 3069-42-9), octadecyl triethoxysilane (C24H52O3Si/CAS no. 7399-00-0), and/or mixtures thereof. The hydrophobicity of a coated surface can also be adjusted or modified by addition of hydrophobic or hydrophilic groups. The addition of silanes with a long alkane chain, for example, octadecyl trimethoxysilane (C21H46O3Si/CAS no. 3069-42-9), produces a hydrophobic surface. A hydrophilic surface is produced by the addition of polar silanes, for example, 3-aminopropyltrimethoxysilane (C6H17NO3Si/CAS no. 13822-56-5) or N-(hydroxyethyl)-N-methylaminopropyltrimethoxysilane (C9H23NO4Si/CAS no. 330457-46-0). Thus, the surface properties of the coating can be controlled as a function of the fastening or sealing element used later. Depending on the fastening or sealing element used later, mixtures of hydrophilic and hydrophobic silanes can also be used.

The active cleaning is preferably done in a step after application of a solution of a cleaning agent and a surface-modifying substance. The solution can be wiped off with a felt or sponge after a short reaction period.

The coating can be activated and cleaned with a plasma. This is done before the application of the primer if one is provided. The term “plasma” means a partially ionised gas. Molecular fragments that produce greater adhesiveness of the surface with the fastening or sealing element used are produced on the surface by the ionised gas.

The attachment of the fastening or sealing element on the coating is preferably done by direct extrusion thereon. An extrusion nozzle is guided over the pane. The extruded material is applied directly onto the pane with the extrusion nozzle and cures there. Methods for the direct extrusion of fastening or sealing elements are known per se to the person skilled in the art.

Alternatively, however, the fastening or sealing element can also be extruded first and cured and subsequently attached on the coating, for example, using an adhesive or a double-sided adhesive tape.

The formation of the seal or a profile strip is done either at a molecular level, for example, by living polymerisation, chain polymerisation, polycondensation, polyaddition, or in the case of thermoplastic elastomers, by heating and subsequent cooling. To improve the elastic properties, polymeric cross-linking can also follow, for example, by increased temperature, atmospheric humidity, addition of oxygen.

If the fastening or sealing element contains moisture-reactive hotmelt adhesives, the application is preferably done at temperatures from 80° C. to 200° C. The moisture-reactive hotmelt adhesive can be applied via an appropriately heated nozzle.

At room temperature (25° C.), hot-curing adhesives contain flowable organic and/or inorganic polymers as well as copolymers and mixtures thereof. If the fastening or sealing element contains hot-curing adhesives, increased temperatures compared to room temperature, in the range from 50° C. to 300° C., are necessary for the cross-linking of the organic and/or inorganic polymers.

The adhesive curing time depends on the adhesive used. After heat treating, the adhesive already has high processing stability such that the bonded parts can be packaged even before reaching final strength.

The invention further includes the use of a pane according to the invention as a vehicle pane or component of a vehicle pane, preferably a motor vehicle roof panel, in particular for an automobile. However, the pane can also be used as a windshield, rear window, or side window.

The invention is explained in detail in the following with reference to drawings and exemplary embodiments. The drawings are schematic representations and not true to scale. The drawings in no way restrict the invention.

They depict:

FIG. 1 a plan view of the interior-side surface of an embodiment of the pane according to the invention with a thermal-radiation-reflecting coating,

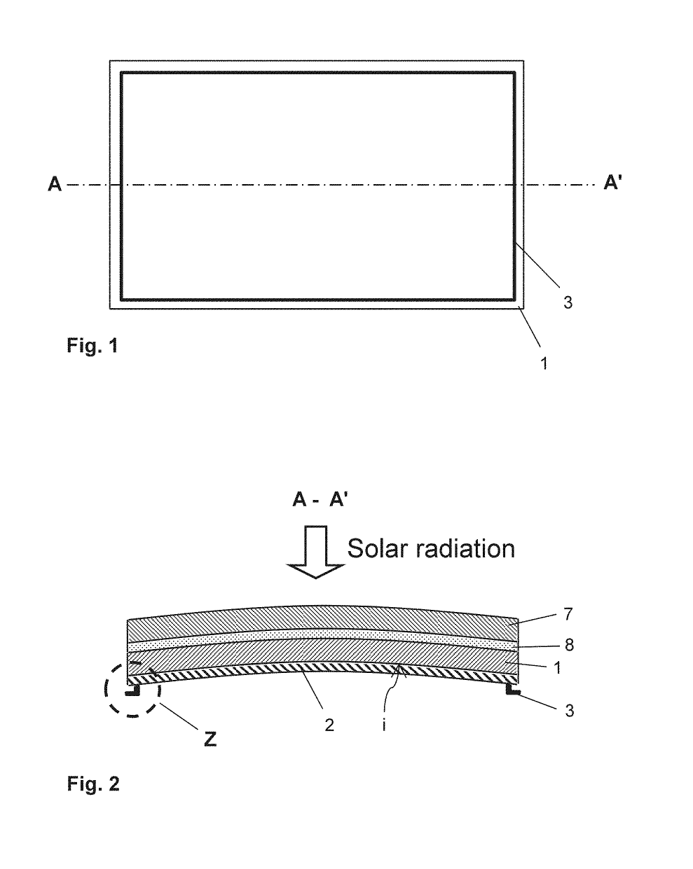

FIG. 2 a cross-section along A-A′ through the pane of FIG. 1,

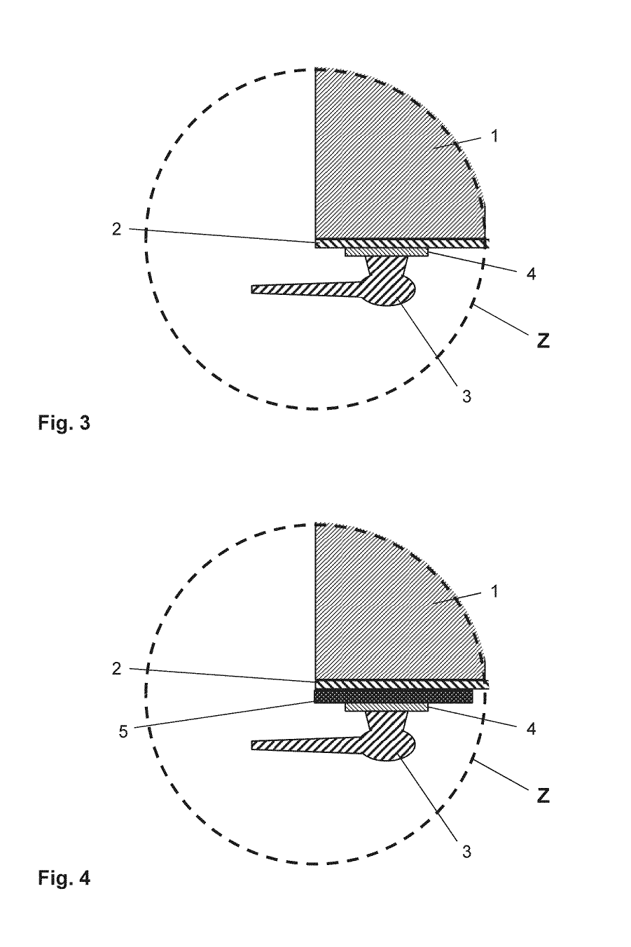

FIG. 3 an enlarged view of the detail Z of FIG. 2,

FIG. 4 an enlarged view of the detail Z of another embodiment of the pane according to the invention,

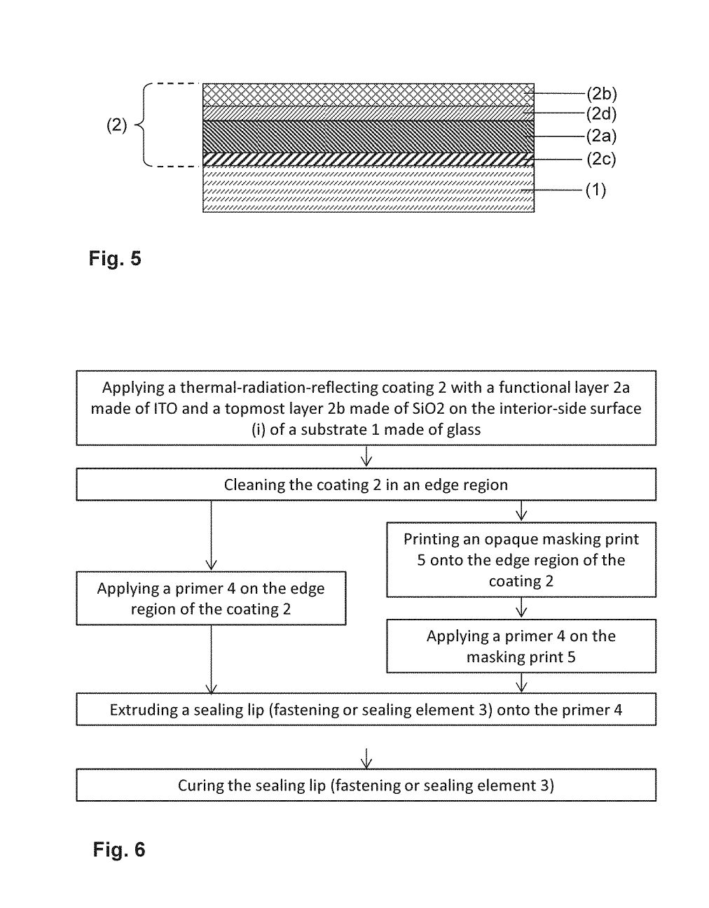

FIG. 5 a cross-section through a substrate with an embodiment of the thermal-radiation-reflecting coating according to the invention,

FIG. 6 a detailed flowchart of two embodiments of the method according to the invention, and

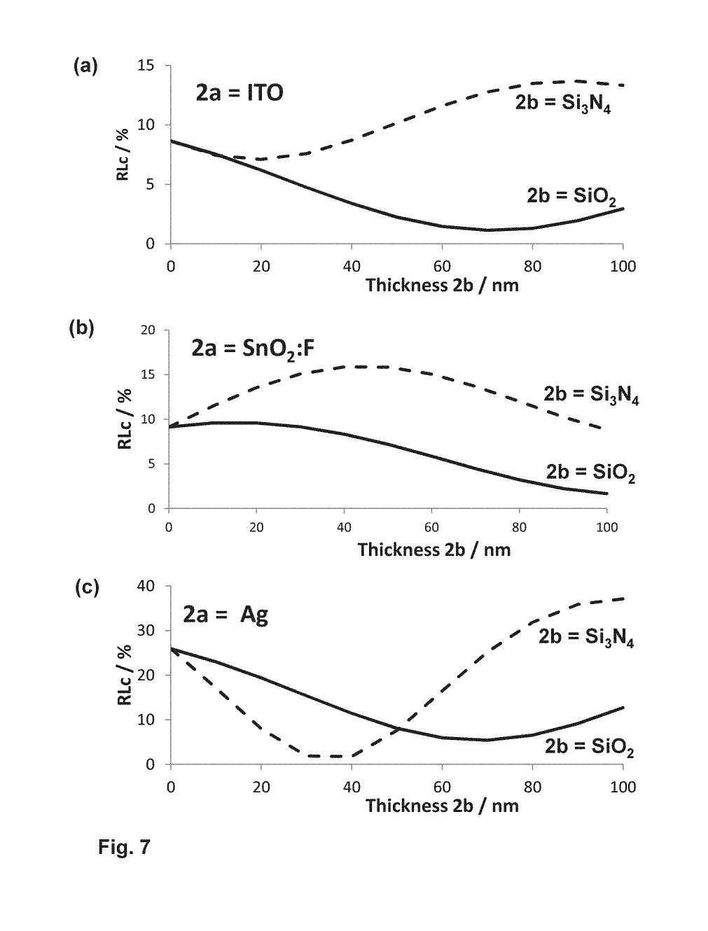

FIG. 7 a diagram of the level of reflection of coated panes with different functional layers and different topmost layers.

FIG. 1, FIG. 2, and FIG. 3 depict in each case a detail of a pane according to the invention. The pane is the roof panel of a motor vehicle and is implemented as a laminated pane (composite pane). It comprises a substrate 1 according to the invention, which functions as an inner pane, and an outer pane 7, which are bonded to one another via a thermoplastic intermediate layer 8. The outer pane 7 and the substrate 1 are made of soda lime glass and and have, in each case, a thickness of 2.1 mm. The thermoplastic intermediate layer 8 is implemented as a 0.76-mm-thick film made of PVB. The roof pane has, as customary in the automotive sector, a curvature.

The surface of the substrate 1 facing away from the outer pane 7 is the interior-side surface i of the substrate 1 and of the roof panel. It is intended to face the vehicle interior in the installed position. The interior-side surface i is provided over its entire surface with a thermal-radiation-reflecting coating 2. The coating 2 includes a functional layer based on indium tin oxide (ITO) and has as its topmost layer a layer based on SiO₂. By means of the arrangement on the interior-side surface i, the coating 2 acts as a so-called “low-E coating”.

The topmost layer according to the invention enables direct attachment of a polymeric fastening or sealing element 3. The removal of the coating 2 in the region of the fastening or sealing element 3 before its attachment can, consequently, advantageously be omitted. In the exemplary embodiment, the surface i with the coating 2 is pretreated with a primer 4, and the fastening or sealing element 3 is implemented as a sealing lip extruded thereon. The sealing lip is cured directly on the pane surface and is attached on the pane via no adhesive other than the primer. The sealing lip protrudes beyond the side edge of the pane and, after installation in the vehicle body, seals the gap between the pane and the body, by which means, in particular, driving noises can be reduced.

FIG. 4 depict a detail of an alternative embodiment of the pane according to the invention. Here, the fastening or sealing element 3 is not attached directly on the coating 2. Instead, an opaque masking print 5 made of a black enamel is applied on the coating 2, as is customary in the edge region of motor vehicle panes. The fastening or sealing element 3 is, in turn, attached via a primer 4 on the masking print 5. Here, the advantage also resides in the topmost layer based on SiO₂, which enables the printing-on of the coating 2.

FIG. 5 depicts an exemplary embodiment of a substrate 1 with a thermal-radiation-reflecting coating 2 according to the invention. The coating 2 is a stack of thin layers, consisting, starting from the substrate 1, of an adhesive layer 2c, a functional layer 2a, a barrier layer 2d, and a topmost layer 2b. The layer sequence with exemplary materials and layer thicknesses is presented in Table 1.

TABLE 1

| Reference character | | Material | Thickness |
|---|---|---|---|
| 2b | 2 | SiO₂:Al | 70 nm |
| 2d | | Si₃N₄:Al | 10 nm |
| 2a | | ITO | 120 nm |
| 2c | | SiO₂:Al | 35 nm |

| | | |
|---|---|---|
| 1 | Glass | 2.1 mm |

The adhesive layer 2c is made of SiO₂, which is doped with aluminium. It improves the adhesion of the layers applied thereabove on the substrate 1. The functional layer 2a is made of ITO and has the reflecting properties relative to thermal radiation. The barrier layer 2d it is made of Si₃N₄, which is doped with aluminium. It prevents corrosion of the functional layer 2a during a temperature treatment of the coated pane, as occurs, for example, at the time of bending or laminating the pane. The topmost layer 2b is again made of SiO₂, which is doped with aluminium. The topmost layer 2b acts, on the one hand, as an antireflection layer, which increases the transparency of the coated pane. On the other hand, it enables the direct attachment of a polymeric fastening or sealing element 3 or of an opaque masking print 5.

FIG. 6 depicts, by way of example, two embodiments of the method according to the invention.

FIG. 7 depicts simulations of the level of reflection RLc of thermal-radiation-reflecting coatings 2 as a function of the functional layer 2a and the topmost layer 2b. The simulations compare the antireflective action of the topmost layers 2b made of Si₃N₄ and SiO₂. Functional layers 2a based on silver are effectively antireflective by topmost layers 2b based on Si₃N₄ up to a thickness of approx. 50 nm (FIG. 7c). From the prior art, it is known that a topmost layer based on Si₃N₄ enables direct attachment of polymeric fastening or sealing elements 3. However, it is clear from the simulations that such a topmost layer 2b based on Si₃N₄ in connection with functional layers 2a based on TCOs does not result in effective antireflection—the topmost layers 2b based on SiO₂ according to the invention are suitable for this (FIG. 7a,b).

### EXAMPLE 1—ADHESION PROPERTIES

Test panes according to the invention and comparative panes were produced with a thermal-radiation-reflecting coating 2 with a functional layer 2a made of ITO and a sealing lip attached thereon as sealing element 3. The coating 2 on the test panes according to the invention differed from the coating 2 on the comparative panes only through the material of the topmost layer 2b: according to the invention, SiO₂ was used here, TiO₂ in the comparative panes. The panes with the sealing element 3 were artificially aged by temperature, moisture, and salt treatment. Then, the adhesion of the sealing element 3 was verified by means of a manual peel test: the sealing element 3 was cut down to the substrate 1 and then peeled off along its direction of extension. Then, the fracture pattern was evaluated per DIN EN ISO 10365. Cohesive breakage (breakage within the sealing element 3) is acceptable, whereas adhesive breakage (release of the entire sealing element 3 from the coating 2) is unacceptable.

The results are presented in Table 2. It is clearly discernible that the topmost layer 2b according to the invention resulted in all cases in good adhesive behaviour, whereas that was the case in only one fourth of the cases with the comparative panes.

TABLE 2

| | Cohesive breakage | Adhesive breakage |
|---|---|---|
| Topmost layer 2b | (acceptable) | (unacceptable) |
| SiO₂ | 100% | 0% |
| TiO₂ | 25% | 75% |

Thus, not all topmost layers 2b suitable as antireflection layers are suitable for direct application of a polymeric sealing element 3. This is enabled by the selection according to the invention of the topmost layer 2b based on SiO₂. This result was unexpected and surprising for the person skilled in the art.

### EXAMPLE 2—PRINTABILITY

Test panes according to the invention and comparative panes were produced with a thermal-radiation-reflecting coating 2 with a functional layer 2a made of ITO and a black enamel printed thereon as an opaque masking print 5. The coating 2 on the test panes according to the invention differed from the coating 2 on the comparative panes only by the material of the topmost layer 2b: according to the invention, SiO₂ was used here, in the comparative pane, Si₃N₄.

The enamel was applied on the coated panes at different temperatures. Then, the masking print 5 was evaluated visually (surface and along a fracture edge). The observations are summarized in Table 3.

TABLE 3

| Topmost | | | |
|---|---|---|---|
| layer 2b | T = 615° C. | T = 650° C. | T = 700° C. |
| SiO₂ | Good result | Good result | Good result |
| Si₃N₄ | Very high porosity | High porosity and | Formation of large |
| | and coarseness, | coarseness, poor | blisters, detachment |
| | very poor sintering | sintering | of the enamel |

The results show that the topmost layer 2b made of SiO₂ according to the invention is compatible with the opaque masking print 5, but the known topmost layer made of Si₃N₄ is not. This result was unexpected and surprising for the person skilled in the art.

### LIST OF REFERENCE CHARACTERS

(1) substrate
(2) thermal-radiation-reflecting coating
(2a) functional layer of 2
(2b) topmost layer of 2
(2c) adhesive layer of 2
(2d) barrier layer of 2
(3) fastening or sealing element
(4) primer
(5) opaque masking print
(7) outer pane
(8) thermoplastic intermediate layer
(i) interior-side surface
A-A′ section line
Z enlarged detail

1. A pane for separating an interior from an external environment, comprising:
a substrate;
a thermal-radiation-reflecting coating on the interior-side surface of the substrate, the thermal-radiation-reflecting coating having at least one functional layer containing a transparent conductive oxide and a topmost layer containing silicon dioxide; and
a polymeric fastening or sealing element on the thermal-radiation-reflecting coating.

2. The pane according to claim 1, wherein the polymeric fastening or sealing element is arranged in direct contact with the thermal-radiation-reflecting coating.

3. The pane according to claim 1, wherein an opaque masking print is arranged between the thermal-radiation-reflecting coating and the fastening or sealing element.

4. The pane according to claim 1, wherein the polymeric fastening or sealing element comprises a sealing lip, an adhesive bead for fastening the pane or an adhesive for fastening an attachment part on the pane.

5. The pane according to claim 1, wherein the fastening or sealing element contains polyurethane, polyolefin, polysulfide, poly-epoxy, rubber such as natural rubber, nitrile rubber (NBR), styrene butadiene rubber, butadiene acrylonitrile rubber, ethylene propylene diene rubber, silicone rubber such as RTV—(room-temperature-vulcanizing) silicone rubber, HTV—(high-temperature-vulcanizing) silicone rubber, peroxide-vulcanising silicone rubber, or addition-vulcanising silicone rubber, polyacrylate, styrene/butadiene block copolymer (SBS), ethylene propylene diene rubber (EPDM), and/or a thermoplastic elastomer (TPE).

6. The pane according to claim 1, wherein the fastening or sealing element contains heat-curing polymers, moisture-curing polymers, or UV-curing polymers.

7. The pane according to claim 1, wherein the substrate contains glass.

8. The pane according to claim 1, wherein a primer is applied between the thermal-radiation-reflecting coating and the fastening or sealing element.

9. The pane according to claim 8, wherein the primer contains polyisocyanate, reactive silane, methacrylate, and/or polyurethane.

10. The pane according to claim 1, wherein the functional layer contains at least fluorine-doped tin oxide, antimony-doped tin oxide, and/or indium tin oxide.

11. The pane according to claim 1, wherein the topmost layer has a thickness of 20 nm to 150 nm.

12. A method for producing a pane with a thermal-radiation-reflecting coating and a polymeric fastening or sealing element, comprising:
(a) applying a thermal-radiation-reflecting coating on the interior-side surface of a substrate, wherein said coating has at least one functional layer containing a transparent conductive oxide and a topmost layer containing silicon dioxide; and
(b) attaching a polymeric fastening or sealing element to said coating.

13. The method according to claim 12, wherein between the process steps (a) and (b), a primer is applied on said coating.

14. The method according to claim 12, wherein said coating is treated between the process steps (a) and (b) with a cleaning solution.

15. A method for using a pane for separating an interior from an external environment; comprising:
providing a pane for separating according to claim 1; and
using the pane for separating as a vehicle pane or a component of a vehicle pane.

16. The method according to claim 15, wherein the component of a vehicle is a motor vehicle roof panel.

17. The method according to claim 14, wherein the cleaning solution contains a silane, a surfactant, an alcohol, a ketone, or mixtures thereof.

18. The pane according to claim 6, wherein the fastening or sealing element contains moisture-reactive hot-melt adhesives, the moisture-reactive hot-melt adhesives including polyurethane-prepolymers, polyesters, polyolefins, polyamides, or mixtures or copolymers thereof, or hot-curing adhesives, such as polyurethanes, silicones, polyacrylates, and poly-epoxies (epoxy resins) or mixtures thereof.

19. The pane according to claim 10, wherein the functional layer has a thickness of 40 nm to 200 nm.

20. The pane according to claim 11, wherein the topmost layer has a thickness of 40 nm to 100 nm.
